(19) United States
(12) Patent Application Publication
(10) Pub. No.: US 2008/0214161 A1
(43) Pub. Date: Sep. 4, 2008

(54) Location Based Push Presence and Profile on a Wireless Communications Device

(75) Inventor: Martin Jakl, London (GB)

Correspondence Address: SYNNESTVEDT LECHNER & WOODBRIDGE LLP, P O BOX 592, 112 NASSAU STREET, PRINCETON, NJ, 08542-0592, US

(73) Assignee: SYMB, London (GB)

(21) Appl. No.: 11/915,200

(22) PCT Filed: May 25, 2006
(86) PCT No.: PCT/GB2006/001918

§ 371 Date: Apr. 2, 2008

(30) Foreign Application Priority Data
May 26, 2005 (GB) 0510794.1

(51) Int. Cl. H04Q 7/22

(52) U.S. Cl. 455/414.2

(57) ABSTRACT

Changes in profile and/or presence information are pushed to a mobile communications device, in dependence upon device location or other application data stored on the device, such as calendar data, in order to ensure appropriate device behaviour. In this manner, the operation of the device can be automatically controlled in social situations or locations where the operation of mobile phones or other mobile computing devices may be regarded as irritating, disruptive or damaging, such as in concerts and libraries.

The present invention relates to a method of operating a wireless communications device, and in particular to a method for integrating profile, presence status and location information on a wireless communication device.

The term wireless communications device currently applies to mobile telephones and other devices capable of using modern cellular telephone networks, and the description of this invention makes reference to these as being the most readily understandable domain in which this invention might be applied.

However, it is not intended or envisaged that this invention should be limited in its applicability to currently available forms of mobile telephones. As modern electronic computing devices functionally converge, it is to be expected that many other types of device will also be capable of communicating wirelessly. The term wireless communication device should therefore be expansively construed to include any electronic device which includes an ability to receive wireless communications of any type. Hence, this term is intended to include personal devices such as desktop computers, laptop computers, Personal Digital Assistants (PDAs), Smartphones, Digital Cameras (still and movie), Digital Music Players as well as many other industrial and domestic devices ranging from gaming devices to cash machines (ATMs) to transportation vehicles of all kinds, which may include means for receiving and communicating information to a traveller.

The rapid growth of the various forms of digital and electronic communications over the last few decades has seen the development of a number of technologies and concepts in the wireless communication area which had not previously been well known.

These technologies and concepts include:
Device profiles: The use of device profiles is becoming well-known on advanced mobile phones, where a number of different profiles are commonly provided. These profiles group together the way the phone behaves in respect of user alerts, which include items such as ring tones and vibration alerts. Profiles commonly have recognisable names such as ‘Meeting’ ‘Outdoor’ ‘Silent’ and ‘Normal’, and they tailor the device to ensure that it behaves in socially appropriate ways when in specific sets of situations. While they are commonly used to modify audible user alerts they may be extended to define any type of situation appropriate behaviour for a device; for instance, key clicks in some situations may be regarded to be as irritating as rings, while visible prompts can be disruptive in certain situations, such as photographic darkrooms.
Presence: The use of presence information is becoming much more common with the growth of instant messaging systems (IM). These are textual messaging systems similar to email in some respects. However, the key difference is that IM systems do not employ a central messaging server to store messages from a sending client until such time as the receiving client is ready to collect them. Instead, an instant message is delivered directly from the sender to the recipient. Presence information is primarily used to convey a potential recipient's status to the person seeking to send them a message. As examples, the recipient could be freely available, available but busy, off-line, out to lunch; and so on. Presence information can also give information to the sender as to the best means of contact at that point in time; for example, if the recipient is out to lunch, presence information could let the sender know whether he/she was answering the phone or not, or whether he/she would be able to answer an email on their return.
Location Based Services (LBS): These services are rapidly becoming well established, both on mobile wireless computing devices today, and also in less mobile devices included in transportation vehicles. LBS capability may be built into a device or may be obtained by linking a device to a dedicated positioning instrument. In either case, using one of a number of possible positioning technologies, the device concerned is able to determine its location and use that as input data for subsequent behaviour. By communicating location to other devices, such as network servers, appropriate services can be delivered to the device upon request. Common use cases for LBS include identifying locations and routes, finding convenient services (such as the nearest restaurant or petrol station) and looking up localised traffic information.

However, the three concept domains described above (profile, presence and LBS) are, in essence, mutually orthogonal technologies. That is to say, presence information can be changed without any consequent impact on phone profile, and profiles can be changed without any consequent impact on presence information. And, even though an LBS equipped device is capable of ascertaining when it has been moved from one location to another, there is no consequent update of presence status when the user leaves one type of location, such as an office where a first presence profile might prevail, for another type of location, such as a home, where the first presence profile might be deemed unacceptable.

Furthermore, even though it is known that it is desirable to automatically link location to profile, there is also no convenient way for the behaviour of mobile phones to be automatically modified when in ‘restricted use’ locations, so that, for example, a device can be switched to a silent mode in libraries or concerts, or switched to flight mode in petrol stations, teaching establishments or hospitals.

It is also notable in this connection that presence status, as published currently on a server, is simply a reflection of the owner's expected usage of his/her own device. Another party, (such as a proprietor, landlord, or event organiser) who has a legitimate interest in automatically adjusting the presence data published by mobile devices, currently has no means of doing this, either directly or via network operators.

This invention seeks to remedy these deficiencies in the prior art and enables the modification of existing devices and the manufacture of new devices which are substantially enhanced over the current generation of mobile computing devices.

According to a first aspect of the present invention there is provided a method of operating a computing device comprising automatically modifying the profile and presence information of a first mobile computing device in response to receipt of a request delivered from a further device over a wireless communications medium, and wherein the transmission of the said request is dependent upon the physical location of the first device.

According to a second aspect of the present invention there is provided a computing device arranged to operate in accordance with the method of the first aspect

According to a third aspect of the present invention there is provided an operating system for causing a computing device to operate in accordance with the method of the first aspect.

Embodiments of the present invention will now be described, by way of further example only, with reference to the accompanying drawings in which:

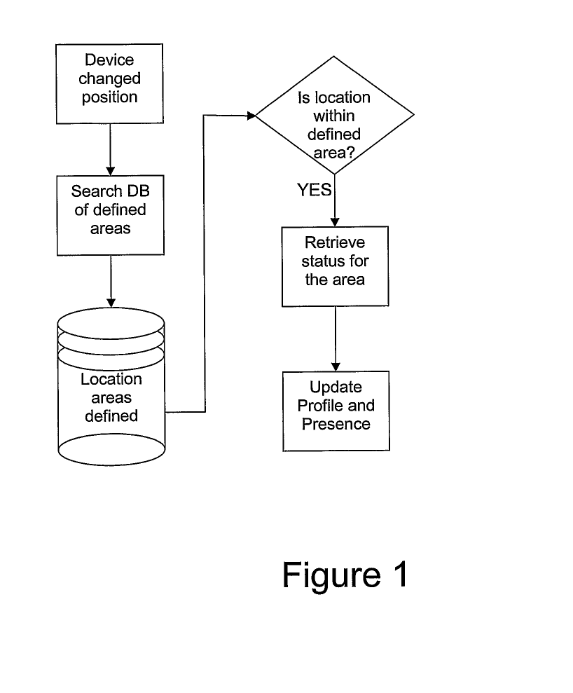

FIG. 1 shows a flowchart illustrating a first embodiment of the present invention where the profile and presence information are updated in dependence upon device location; and

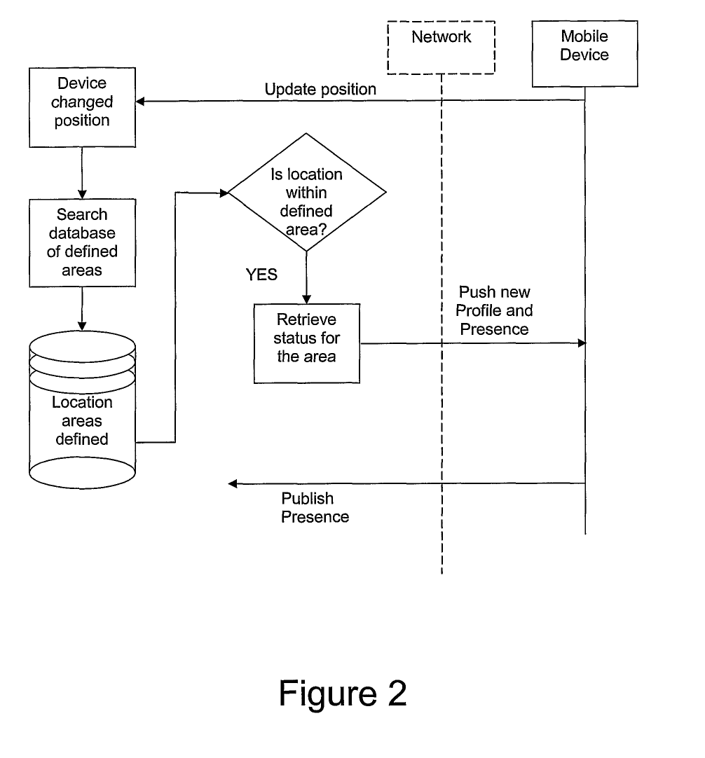

FIG. 2 shows a flowchart illustrating a second embodiment of the invention where profile and presence information are pushed to a device dependent on the device location.

The invention is described below with reference to a wireless communications device in the form of a mobile phone which is under the control of an operating system capable of controlling the three concept domains of profile, presence, and LBS. As mentioned above, these three concept domains are, in present devices, mutually orthogonal technologies, so a change in one domain has no affect on the others. Therefore, as a first feature of this invention, the presence status is integrated with device profile so that when one is changed by the user the other is updated appropriately. Thus, for example, when a “meeting” profile is selected then the presence status is published as “Do Not Disturb”.

The profile and presence domains are then integrated with location based services so that the user of a device can define areas where respective profiles and presence status should be applied, as shown in FIG. 1. Therefore, as an example, a user can define an area around his/her place of work where a first particular profile and presence status would be automatically selected, and a second area or location, such as an area around the user's place of worship, where a second profile and presence status would be automatically selected. These defined areas may be stored in a database on the device which is searched when the device is sensed to change position. If the device is determined to be located within one of the areas defined by the user, the status for the area concerned is retrieved, and the profile and presence for the device are updated accordingly. This process is shown in FIG. 1.

In an alternative embodiment of the invention this second phase of the invention may be refined by integrating profile, presence status and location with the calendar or agenda functions found on many mobile computing devices. Then, for example, the profile and presence set for a location such as a church can be different on a Sunday morning or other religious festival days in comparison to other days of the week, thereby ensuring that the device behaves appropriately during religious services but is not limited by the applied presence or profile changes when the user is in the vicinity of the church at other times.

A further aspect of this invention enables presence and profile changes to be transmitted, or pushed, to mobile computing devices by communications networks when they are in specific locations and areas, as shown in FIG. 2. The location of the mobile device can be determined using a variety of known positioning techniques, including the Global Positioning system (GPS), or cell-based triangulation or a combination of these and other technologies; some of these techniques would be carried out by the device itself with the results being transmitted to the network, while others might be carried out by the mobile communications network itself. In either case, the network can search a database of defined areas, and if the device is determined as being within a defined area, retrieve the status information for that area and send a request or an instruction to the device based on its perceived location, which results in the device altering either the published presence status or the device profile or both. Thus the presence status and/or device profile are pushed to the device.

A refinement of this push technique of this invention, similar to the refinement of the second phase, is to integrate the pushed profile and presence data with a calendar. So, for example, when a user books theatre tickets, the vendor can push appropriate presence and profile changes to the mobile device which are linked to the time when the performance is due to occur. The device will then behave appropriately at the time of the performance without intervention of the user.

In a further refinement of the invention, the device is enabled to automatically revert to a previous presence and profile either when the device has moved out of the specific location or area which triggered the push changes; e.g. when a user has left a petrol station where for safety reasons the station operator has imposed a ‘safe’ profile (possibly by using a very localised limited range inductive loop technique) whilst the device is on the station premises. Additionally or alternatively, in the case of the integrated calendar push, the device can be enabled to automatically revert to a previous presence and profile after a pre-set interval of time; e.g. the time when a concert is scheduled to finish. In this latter case, the presence information pushed to the device can also include an estimated duration or an indication of the expected time when the owner of the device is again likely to be contactable. In this latter case the pre-set interval of time can be updated during the initially pushed pre-set interval so that the device will not revert to a previous presence and profile until the end of the updated pre-set interval. So, for example, the vendor of the theatre tickets referred to above, or the management of the theatre itself could monitor the theatrical performance, and as soon as it is realised that the performance is running late and therefore expected to overrun, the updated presence and profile information can be pushed to the device. In the case where the presence information pushed to the device also includes an estimated duration or an indication of the expected time when the owner of the device is again likely to be contactable, this information can also be updated as a result of the new pushed information. This latter information update may initiate from the mobile device itself or from a server of a network operator.

It should be noted that there are a number of possible methods for pushing or transmitting the request or instruction using extensions to a variety of existing technologies. These include cell broadcast, Short Message Service (SMS), the Wireless Application Protocol (WAP) which is described at http://developer.openwave.com/dvl/support/faqs/faq_wappush.htm), Extensible Messaging and Presence Protocol (XMPP) (described at http://www.jabber.org/jsf/) or by means of the Session Initiation Protocol (SIP) (described at http://www.ietf.org/html.charters/sip-charter.html). Any of these technologies can be used to transmit the new profile and presence configuration. In response, the receiving device then switches into requested mode (ideally automatically, but optionally upon a manual confirmation) whereupon the profile would change and the updated presence status would be published to other users. The implementation of this invention should not be considered as being limited to any specific existing or future particular push technology.

Furthermore, it should also be noted that there are also a number of possible positioning technologies that could be used to obtain the location of the device. Currently, these all have their limitations and compromises. For instance, GPS is extremely accurate, but does not work well in indoor locations and other places when a device has no clear line of sight to a positioning satellite, while cell triangulation, which works well in indoor environments, is often insufficiently accurate to determine location to the granularity of a specific building. It is possible, therefore, that a working combination of the various existing positioning methods, rather than any single method in isolation, is adopted to ensure the positioning accuracy needed to implement this invention in particular locations and areas. However, should an alternative positioning technology become available which is not limited in respect of granularity or accessibility, this invention can also be adopted for use with such a technology. Therefore, the implementation of this invention should not be considered as being limited to any single existing or future particular positioning technology or to any combination of such technologies. All that is required is the availability of positioning information, however that may be derived.

It should also be noted that presence and profile changes can also be pushed by a local short range communications network which by its nature is limited in scope to a specific location and area. Such short range networking technologies include duplex (two-way) technologies such as Bluetooth, 802.11b compatible wireless networking and infra-red, and also simplex (one-way) broadcast technologies such as local FM radio or induction loops which are commonly used as public address systems for the hard of hearing. These short-range networks could be used as a complementary or as a substitute technology in cases to achieve the same effect where GPS and cellular technologies were either unavailable or exhibit insufficient accuracy and may be used to improve location granularity in certain circumstances and locations.

Therefore, this invention provides the ability for presence and profile data to be pushed to mobile wireless computing devices on the basis of their location. Typical examples are
A concert hall or a theatre, where management could push appropriate profile and presence information to all users within the specific area of their venue.
Management of public areas such as petrol stations or hospitals, whereby all devices in given area would be switched to ‘silent’ profile using ‘push-presence’ functionality with the new presence status being published accordingly.

In these types of scenarios, the identification of the devices present in the area concerned could either be retrieved from a network and/or from the devices themselves.

This invention also enables users or a device to associate presence and profile data with defined locations and areas. Thus, one set of profile/presence data would be enforced for ‘work’, one set for ‘home’ and another one for ‘public’ areas (defined as neither of previous two locations).

Although the present invention has been described with reference to particular embodiments, it will be appreciated that modifications may be effected whilst remaining within the scope of the present invention as defined by the appended claims.

1. A method of operating a computing device comprising automatically modifying the profile and presence information of a first mobile computing device in response to receipt of a request delivered from a further device over a wireless communications medium, and wherein the transmission of the said request is dependent upon the physical location of the first device.

2. A method according to claim 1 wherein the wireless communication medium comprises
a. a short range broadcast networking technology including but not limited to Bluetooth, infra-red and 802.11b compatible wireless networking;
b. simplex broadcast technologies including but not limited to FM radio or induction loop; or
c. wide area broadcast technologies including but not limited to cellular telephone networks.

3. A method according to claim 1 wherein the physical location of the first mobile computing device is determined via
a. GPS;
b. Cell triangulation
c. assumed proximity to a specific network or simplex short-range broadcast point; or
d. any combination of the above
or any other positioning technology either by itself or in combination with any of the above.

4. A method according to claim 1 wherein the transmission of the said request is made using one of a standard range of protocols including but not limited to
a. SMS;
b. WAP;
c. XMPP; or
d. SIP
or any extensions or combinations of the above.

5. A method according to claim 1 wherein the presence information is amended as a consequence of a change in profile.

6. A method according to claim 1 wherein the change in profile and presence information is accompanied by time and date information which is used to limit the duration of the said change in profile and presence information.

7. A method according to claim 6 wherein the time and date information is updated during the duration of the said change in profile and presence information so as to set a revised limit to the said duration.

8. A method according to claim 1 wherein the change in profile and presence information is cancelled when either the first mobile computing device or the further device determines that a change in the physical location of the first device no longer applies.

9. A method according to claim 1 wherein presence information is amended implicitly as a consequence of a request to a change in profile rather than explicitly in response to a presence information change request.

10. A method according to claim 1 wherein any change in profile or presence information is initiated by the user of the first mobile device rather than as a result of a wireless communications transmission received from a further device.

11. A computing device arranged to operate in accordance with a method as claimed in claim 1.

12. An operating system for causing a computing device to operate in accordance with a method as claimed in claim 1.
